(19) United States
(12) Patent Application Publication
(10) Pub. No.: US 2024/0401954 A1
(43) Pub. Date: Dec. 5, 2024

(54) PEDESTRIAN DEAD RECKONING ESTIMATION FOR DIFFERENT DEVICE PLACEMENTS

(71) Applicant: Apple Inc., Cupertino, CA (US)

(72) Inventors: Xiaoyuan Tu, Sunnyvale, CA (US); Alexander Singh Alvarado, San Jose, CA (US); Jonathan Michel Beard, San Jose, CA (US); Lucie A. Huet, Mountain View, CA (US); Ozhan Turgut, Menlo Park, CA (US); Ryan K. Burns, Santa Clara, CA (US)

(21) Appl. No.: 18/731,060

(22) Filed: May 31, 2024

Related U.S. Application Data
(60) Provisional application No. 63/470,795, filed on Jun. 2, 2023.

(51) Int. Cl. G01C 21/16

(52) U.S. Cl. CPC G01C 21/16

(57) ABSTRACT

Embodiments are disclosed for PDR for different device placements. In some embodiments, a method comprises: obtaining motion data from a motion sensor of a mobile device; determining pedestrian or non-pedestrian class based on the device motion data; determining a placement of the device based on the device motion data; estimating a first direction of travel based on multiple direction of travel sources and the device placement; estimating a first velocity based on the pedestrian or non-pedestrian classification, the first estimate of direction of travel and a first estimate of speed; estimating a second velocity based on a kinematic model and the device motion data; selecting the first estimated velocity or the second estimated velocity based on selection logic; and determining a relative position of the device based on the selected estimated velocity.

### CROSS-REFERENCE TO RELATED APPLICATION

This application claims priority to U.S. Provisional Patent Application No. 63/470,795, filed Jun. 2, 2023, the entire contents of which are incorporated herein by reference.

### TECHNICAL FIELD

This disclosure relates generally to pedestrian dead reckoning.

### BACKGROUND

Pedestrian Dead Reckoning (PDR) is used on mobile devices to assist other navigation methods, or to extend navigation into areas where other navigation systems are unavailable, such as indoor navigation where satellite-based positioning is not available. PDR typically includes estimates of speed and direction of travel (DOT) to determine a pedestrian velocity vector in a local inertial reference frame. Pedestrian velocity estimates can be used by mobile applications for tracking and mapping a user trajectory. Pedestrian velocity estimates may also be used to analyze a user's walking gait for health monitoring (e.g., fall detection) and/or fitness applications. The pedestrian velocity estimates may also be used in spatial audio applications to determine if the user is walking away from a source device (e.g., a computer tablet) as a condition to disable spatial audio associated with content playing on the source device.

### SUMMARY

Embodiments are disclosed for PDR estimation for different device placements. In some embodiments, a method comprises: obtaining motion data from a motion sensor of a mobile device; determining pedestrian or non-pedestrian class based on the device motion data; determining a placement of the device based on the device motion data; estimating a first direction of travel based on multiple direction of travel sources and the device placement; estimating a first velocity based on the pedestrian or non-pedestrian classification, the first estimate of direction of travel and a first estimate of speed; estimating a second velocity based on a kinematic model and the device motion data; selecting the first estimated velocity or the second estimated velocity based on selection logic; and determining a relative position of the device based on the selected estimated velocity.

Other embodiments are directed to an apparatus, system, and computer-readable medium.

Particular embodiments described herein provide one or more of the following advantages. The disclosed embodiments enable PDR estimation using inertial sensors of a mobile device (e.g., smartphone, smartwatch) for different device placements on a user's body, such as on the user's wrist or in a leg pocket (utilizing arm-swing or leg-swing biomechanics), on the body (e.g., in a pocket or backpack) or in-hand such as when the user is holding the device and texting or watching content while walking.

### BRIEF DESCRIPTION OF THE DRAWINGS

FIG. 1 is a block diagram of a PDR system, according to one or more embodiments.

FIG. 2 illustrates example device placements on a user's wrist, body, and in-hand, according to one or more embodiments.

FIG. 3 illustrates a method of estimating DoT based on arm-swing, according to one or more embodiments.

FIGS. 4A-4C are plots illustrating the method for estimating DoT based on arm-swing, according to one or more embodiments.

FIG. 5 is a diagram of a finite state machine (FSM) for registering peaks and valleys in inertial acceleration data, according to one or more embodiments.

FIG. 6 is a flow diagram of logic for calculating a DoT uncertainty value, according to one or more embodiments.

FIG. 7 is a flow diagram of uncertainty model 600 shown in FIG. 6, according to one or more embodiments.

FIGS. 8A-8D illustrate determining DoT for in-hand device placement, according to one or more embodiments.

FIG. 9 is a block diagram of a system for estimating DoT and its associated uncertainty for different device placements, according to one or more embodiments.

FIG. 10 is a block diagram of the pedestrian classifier shown in FIG. 1, according to one or more embodiments.

FIG. 11 is a flow diagram of a process for estimating velocity for different device placements, according to one or more embodiments.

FIG. 12 is a block diagram of a mobile device architecture for implementing the system, features and processes described in reference to FIGS. 1-11.

### DETAILED DESCRIPTION

### Example PDR Estimation System

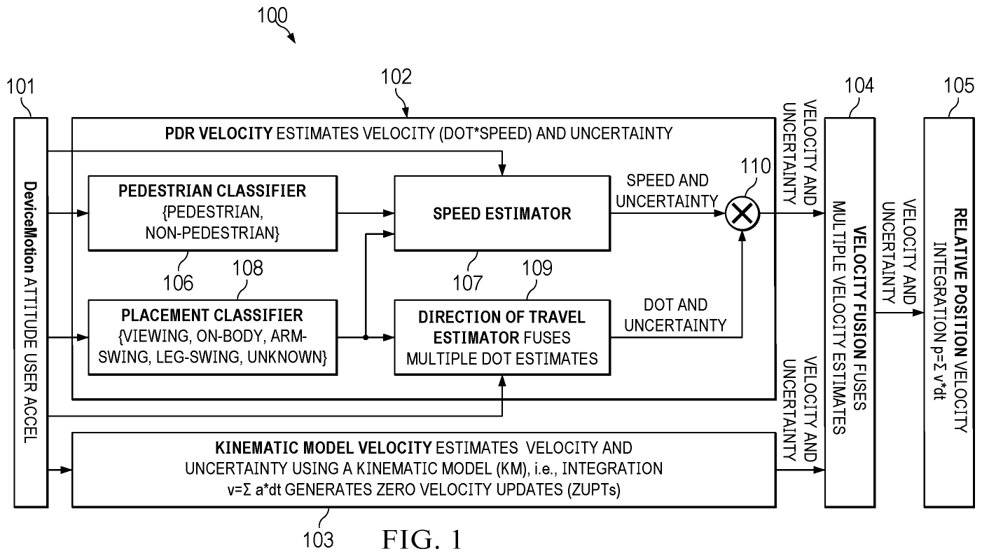

FIG. 1 is a block diagram of PDR system 100, according to one or more embodiments. PDR system 100 includes PDR velocity estimator 102, kinematic model velocity estimator 103 and velocity logic 104.

In operation, device motion 101 (e.g., attitude, acceleration) is input to kinematic model velocity estimator 103. Kinematic Model (KM) velocity estimator 103 estimates the velocity of the device and its associated uncertainty using a kinematic model that integrates the acceleration to obtain velocity. KM velocity estimator 103 also generates zero velocity updates (ZUPTs) for position updates whenever zero velocity is detected. The estimated velocity and associated uncertainty are input to velocity logic 104. Note that the KM velocity estimator 103 is faster than PDR velocity estimator 102 and is therefore used to estimate velocity at the beginning of each epoch as runs for a period of time (e.g., 3 ms) to allow PDR velocity estimator 102 to stabilize.

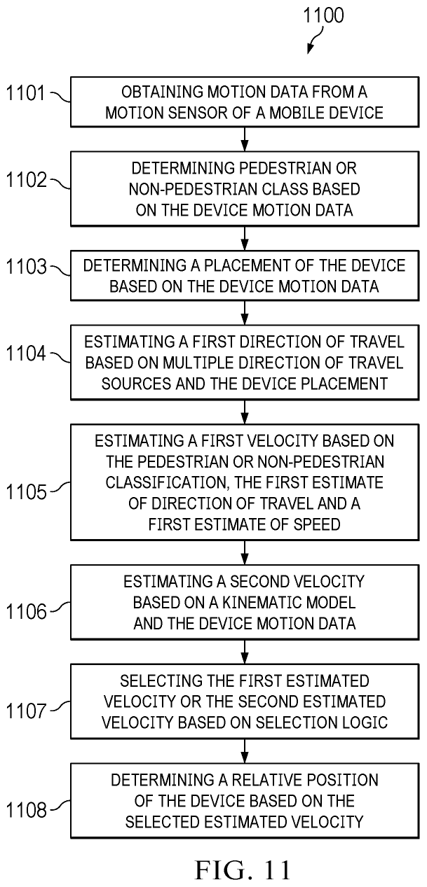

Device motion 101 is also input to PDR velocity estimator 102, which estimates velocity from an estimated speed and an estimated DoT. Pedestrian classifier 106 classifiers device motion 101 as pedestrian walking or non-pedestrian walking, as described more fully in reference to FIG. 11. Placement classifier 108 classifies placement of the device on the user, including in-hand (e.g., holding the device while viewing the display), on-body (e.g., device is in the user's pants pocket, backpack, etc.) or on the user's wrist or leg (e.g., where the device is subjected to arm-swing or leg-swing) and unknown for device motion 101 that cannot be classified. The output of pedestrian classifier 106 (e.g., probability of pedestrian activity) is input to speed estimator 107 which fuses (e.g., averages) multiple speed estimates, and outputs a device speed estimate and associated uncertainty based on the output pedestrian classifier 106. Device motion 101 is input to DoT estimator 109 together with the output of placement classifier 108 is input to DoT estimator 109 together with the output from pedestrian classifier 106 to fuse (e.g., to select between and smooth between transitions) multiple DoT estimates. The output of DoT estimator 109 is a DoT estimate and its associated uncertainty. The outputs of estimators 102, 103 are combined 110 into a single PDR estimated velocity and its associated uncertainty which is input to velocity logic 104.

Velocity logic 104 selects one of the two velocities and their respective associated uncertainty as output to relative position generator 105, which integrates the selected estimated velocity to obtain an estimated relative position. The relative position, estimated velocity, and DoT can be made available to various mobile applications installed on the device, such as indoor navigation, health monitoring, fitness, and spatial audio applications.

In some embodiments, speed estimator 107 includes a neural network (NN) to estimate speed (hereinafter “speed estimation NN”). The speed estimation NN can be a feed-forward regression model. In some embodiments, the speed estimation NN includes multiple stacked hidden layers each with an activation function (e.g., a rectified linear unit (ReLU) activation function) and an output layer (e.g., a “dense linear” layer) that uses linear regression, rather than a softmax or sigmoid activation function. The speed estimation NN receives two estimated velocity vectors: one from pedestrian classifier 106 and one from placement classifier 108. The speed estimation NN outputs a speed estimate and uncertainty, which is combined (e.g., multiplied) with the direction of travel output by DOT estimator 109 to form a PDR estimated velocity vector. The PDR estimated velocity vector and the kinetic model estimated velocity vector output by kinematic model velocity estimator 110 are input into velocity fuser 104, which fuses the two velocity estimates into a single velocity estimate and corresponding uncertainty based on the uncertainties of the two velocity estimates. The single velocity estimate is integrated into a relative position estimate by relative position block 105.

In some embodiments, the speed estimation NN uses the same extracted features (device motion, attitude, user acceleration) as pedestrian classifier 106 and placement classifier 108, respectively. In some embodiments, there are modifications made to the “raw” speed estimate produced by the speed estimation NN. When pedestrian classifier 106 (e.g., a separate classifier NN) outputs FALSE to indicate non-pedestrian, the estimated speed output by the estimated speed NN is automatically clamped to zero. In this way, speed estimator block 107 “fuses” or combines the raw speed estimate from the speed estimate NN and a Boolean value from pedestrian classier block 106 (e.g., a classifier NN indicating pedestrian or not pedestrian) to finalize the speed estimate. When the Boolean value is FALSE, speed would be 0 m/s, which allows drift to be curbed due to speed errors which might accumulate during a semi-static or otherwise non-pedestrian period. When the Boolean value is TRUE, the speed estimate output by the speed estimation NN is accepted and not zeroed out. This operation can be represented mathematically as: revised speed=(raw speed)*Boolean value.

In some embodiments, a second post-processing step for speed estimation is to enforce a maximum bound on the speed estimate (e.g., 3.5 m/s) to prevent large spikes in the PDR velocity estimate due to high acceleration events such as knocks on the device. These velocity spikes would otherwise result in accumulation of position errors, upon velocity integration by relative position block 105. Upper bounding the speed estimate mitigates this error accumulation. This upper bounding can be represented mathematically as: revised speed=max (raw speed, 3.5 m/s).

Apart from maximum-bounding the speed estimate, and similar to the anti-drift goal of combining raw speed with the Boolean value, a third post-processing step can be implemented for raw pedestrian speeds below 0.15 m/s. These low speed values zeroed out. The operation for this can be represented mathematically as: revised speed=(raw speed)*(raw speed>=0.15 m/s). Absent this step, drift in position would accumulate near semi-static or otherwise non-pedestrian scenarios. There is no prescribed order for these speed-gating and speed-bounding operations, so they can be done in any order with the same net effect.

In some embodiments, placement classifier 108 is a feed forward NN. This classifier NN is similar to the classifier NN used by pedestrian classifier 106 but is a 5-class/activity model rather than a 2-class/activity model. There is also no state machine logic succeeding the NN classifier in placement classifier 108, as there is for pedestrian classifier 106. Raw placement probabilities (a vector of 5 total) are passed out of placement classifier 108 directly to the DOT estimator 109, where they might be further processed.

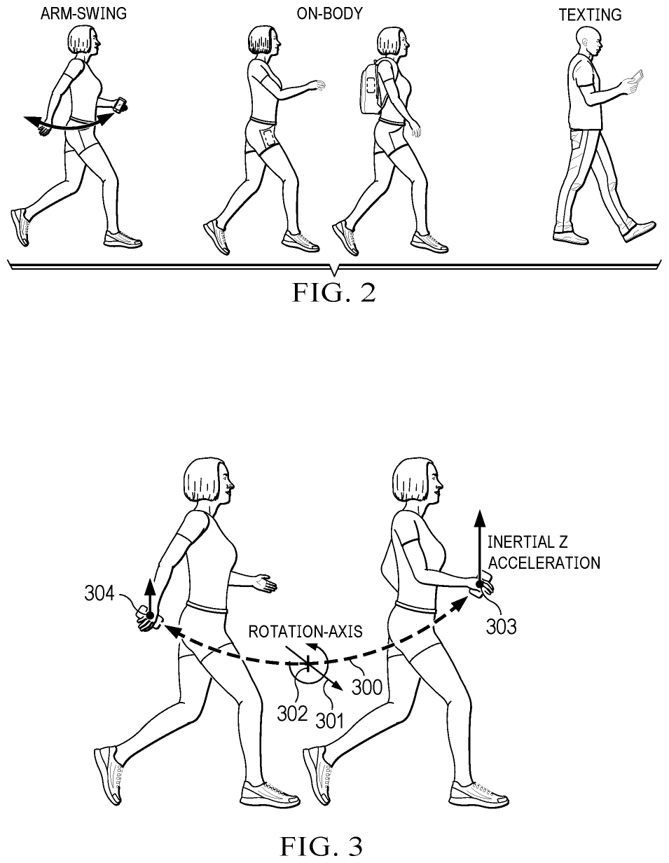

FIG. 2 illustrates example device placements on a user's wrist/leg (e.g., a smartwatch, leg-pocket/strapped to leg), on-body, (e.g., in pants pocket, in backpack) and in-hand (e.g., holding a smartphone or tablet computer while texting), according to one or more embodiments. Observed device motion signatures for a pedestrian during walking differ at different device placements. These motion signatures (arm-swing, leg-swing, on-body, viewing/texting) are leveraged by placement classifier 108 to classify the device placement, so that DoT estimator 109 can select the appropriate DoT model to estimate DoT and its associated uncertainty.

### Example Arm-Swing Leg-Swing DoT Estimation

FIG. 3 illustrates estimating DoT for wrist/leg placement, according to one or more embodiments. When the device is attached to the wrist the device is subjected to arm-swing/leg-sing motion, which can be leveraged to estimate DoT.

### Arm-Swing

To determine arm-swing trajectory 300, a principal axis of rotation 301 of the arm swing is determined which is 90° offset to the DoT, as shown in FIG. 3. It is noted that the highest correlation between the DoT and arm-swing trajectory 300 occurs at point 302, where the swing rotation magnitude reaches maximum. This corresponds to the highest signal-to-noise ratio (SNR) on arm-swing trajectory 300.

Because arm-swing traverses in both backward and forward directions during walking, the direction of arm-swing is disambiguated using inertial vertical acceleration (z component of acceleration) at inflection points 303, 304 on trajectory 300. It is noted that the inertial vertical acceleration (z acceleration component) is higher at forward swing inflection point 303 than backward swing infection point 304, resulting in inflection point 303 being higher than inflection point 303. Accordingly, the arm-swing direction is disambiguated by noting the magnitude of the inertial vertical acceleration at the swing inflection points.

To determine the maximum rotation magnitude, observation periods are extracted by first registering peak rotation magnitude point 301 and inflection points 303, 304 on arm-swing trajectory 300. In some embodiments, the principal axis of rotation at 301 is determined by computing the mean of a buffer of horizontal rotation rate vectors around a peak horizontal rotation magnitude. Inflection points 303, 304 of trajectory 300 are determined by the minimum horizontal rotation rate magnitude. During a swing motion, the maximum rotation magnitude usually corresponds to the lowest point of swing, when the user's hand swings by the side of their body. Hence, the lowest point of the swing is the best moment to capture the DoT/principal rotation axis, since the user's hand may curve a little at the inflection points 303, 304 when their hand is in front or behind their body. At the inflection points 303, 304, the user's hand stops and starts swinging in the opposition direction, and that is where the rotation rate magnitude is close to zero, hence it can be captured by getting the minimum of the horizontal rotation magnitude waveform.

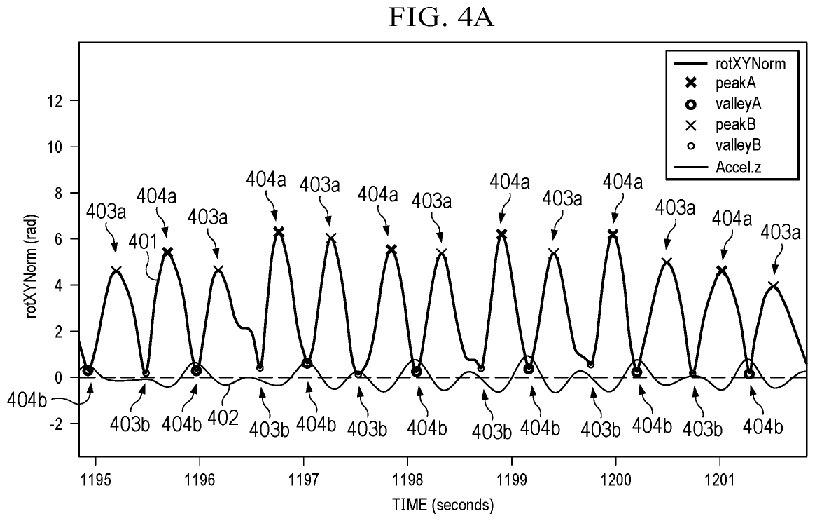

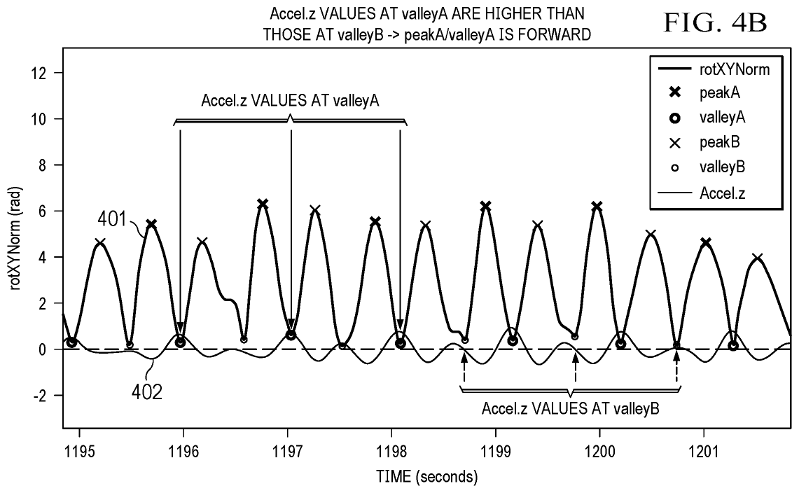

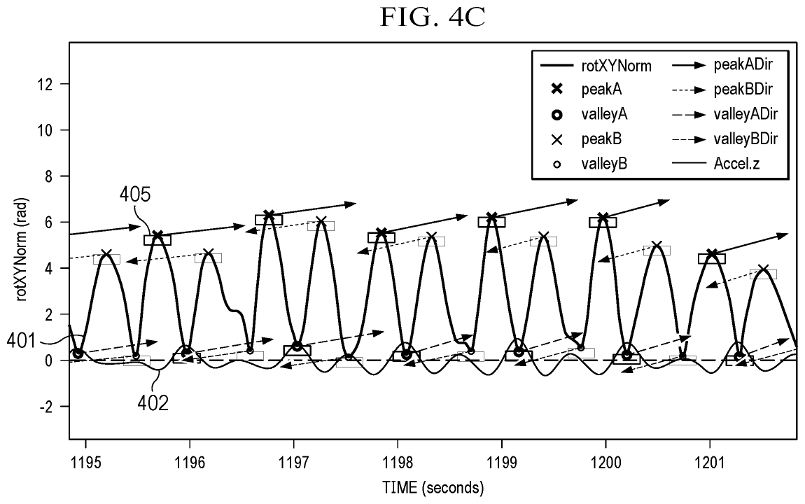

FIG. 4A shows example plots 401, 402 of rotation magnitudes about an inertial horizontal rotation axis of swing (RotXYNorm), and the vertical inertial acceleration (Accel.z), respectively, over a 7 second window of time, as illustrated in FIG. 3. The peak magnitudes in plot 401 are marked with a cross “X.” The rectangles 405 about each peak in FIG. 4C indicates a mean captured around the peak (a buffer of RotXY vectors) to estimate principal axis of rotation 301. The valleys on plot 401 are marked with circles, and indicate inflection points 303, 304, respectively, of arm-swing trajectory 300.

In FIGS. 4A-4C, crosses 404a and circles 404b are labeled as PeakA and ValleyA, respectively, and the crosses 403a and circles 403b are labeled as PeakB and ValleyB, respectively. These are alternating peak and valley pairs corresponding to forward or backward swings, according to one or more embodiments.

FIG. 4C shows plots 402 for vertical inertial acceleration values corresponding to valleys (swing inflection points), according to one or more embodiments. As previously described, inertial vertical acceleration at each associated valley (extremal point of arm-swing) is used to disambiguate arm-swing direction. Note that z values for forward arm-swing ends at z values (shown as 402 values at the 404b circles in FIG. 4C) that are higher than z values for backward arm-swing (shown as 402 values at the 403b circles in FIG. 4C).

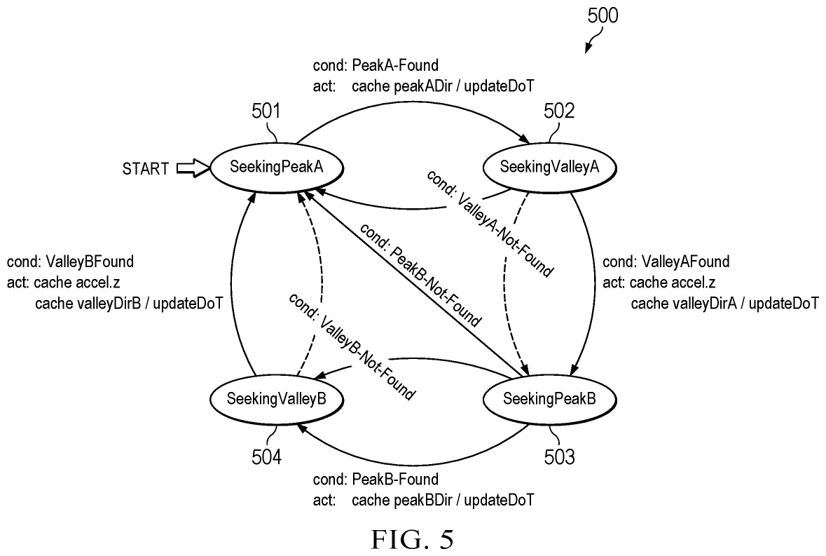

FIG. 5 is a finite state machine (FSM) diagram for registering peaks and valleys in the waveform of the inertial horizontal rotation magnitude/norm, and the associated inertial rotation rate and acceleration data, according to one or more embodiments. FSM 500 starts in SeekingPeakA state 501 which starts a search for a peak A (see FIGS. 4B, 4C) in a window of rotation magnitude data. If a peak A is found (PeakA-Found), the direction of peak A (peakADir, from the vector mean of the buffer of inertial horizontal-XY rotation rates around PeakA) is cached in memory, the DoT is updated (updateDoT) and FSM 500 transitions into Seeking ValleyA state 502, which starts a search for a Valley A. Note that the direction of peak A is the mean of the horizontal rotation rate from the buffer around it. It is the two-dimensional vector of the principal rotation axis in the inertial frame, which, once disambiguated, is used to update the DoT estimate. For example, if peak A is determined to be forward (from inertial z acceleration values associated with Valley As versus inertial z acceleration values associated with Valley Bs), then the buffer of mean of RotXY is used to get the principal rotation axis, which is rotated 90 degrees to get the DoT estimate. The same process applies when peak B is detected, which is backward, so the principal axis of rotation is rotated from peak B by 270 degrees to get the DoT estimate.

If a valley A is not found (ValleyA-Not-Found), FSM 500 transitions back to SeekingPeak A state 501. Otherwise, if valley A is found (ValleyAFound), the vertical acceleration (z component of inertial acceleration vector) and optionally, the direction at Valley A (ValleyDirA, from the vector mean of a buffer of horizontal accelerations around Valley A) are cached in memory, DoT is updated (updateDoT) and FSM 500 transitions into SeekingPeak B state 503.

SeekingPeak B state 503 starts a search for a peak B in the rotation waveform. If a peak B is found (PeakB-Found), the peak B direction (peakBDir) is cached in memory, DoT is updated (updateDoT), and FSM 500 transitions to SeekingValleyB state 504. Seeking Valley B state 504 starts a search for a valley B. If a valley B is found (ValleyBFound), the vertical acceleration, the valley B direction (valleyDirB) are cached in memory, DoT is updated (updateDoT), and FSM 500 transitions to SeekPeakA state 501. If a valley B is not found (ValleyB-Not-Found), FSM 500 transitions to SeekingPeak B state 503.

The uncertainty associated with the DoT estimate grows when the user changes their device holding orientation, e.g., when swapping hands, or the user turns (confound with device orientation reverse). To address these scenarios, the DoT estimation is invalidated and reset when the following logic is TRUE in Equation [1] below:

$$timeSinceLastDoTUpdate 3 > τ \&\& failedRegistrationPeaks \geq 2 \qquad [ 1 ]$$

$$‖ largeYawChangeDetected$$

Referring to the above logic in Equation [1], if the time since the last DoT update is greater than a threshold value and the number of failures to register peaks is greater or equal to 2, or there is a large inertial yaw value detected, then the DoT estimation is invalidated and reset.

### Leg-Swing

Using leg-swings for DoT estimation is the same as for arm-swings, except for the issues described below. In some cases, only a forward leg-swing is observed, causing FSM 500 to reset constantly due to failure of capturing the expected opposite swing direction. To address this issue, when the device is operating in a leg-swing mode, FSM 500 is allowed to proceed without requiring and opposing peak detection, and the dominant peaks provide the DoT estimations.

In some cases, the forward leg swing inflection point is not the deepest valley following a peak due to secondary effects of foot impact dynamics or device movement inside a loose pocket (unlike arm-swings). To address this issue, while in leg-swing mode, the first valley after the peak is when leg-swing stops (before the foot hits the ground). In some embodiments, a narrower valley search window is used to detect the valley.

### Example On-Body DoT Estimation

The DoT for on-body device placement uses the center of mass (COM) of an inertial acceleration curve (a butterfly pattern), where a direction of curvature indicates DoT. The process begins by obtaining acceleration data in an inertial reference frame from a motion sensor (e.g., IMU) of a mobile device carried by a user. In some embodiments, the acceleration data is inertial acceleration with gravity removed. The acceleration data is represented by a space curve in a three-dimensional (3D) acceleration space, where the space curve is indicative of a cyclical vertical oscillation of the user's COM accompanied by a lateral left and right sway of the COM when the user is stepping.

The process continues by computing a tangent-normal-binormal (TNB) reference frame from the acceleration data. The TNB reference frame describes instantaneous geometric properties of the acceleration space curve over time, wherein the T vector of the TNB reference frame is tangent to the space curve, the N vector of the TNB reference frame is a normalized derivative of the unit T vector and the B vector of the TNB reference frame is formed from a cross-product of the T vector and the N vector. The process continues by computing an estimated DoT of the user based on an orientation of the B unit vector in the 3D acceleration space.

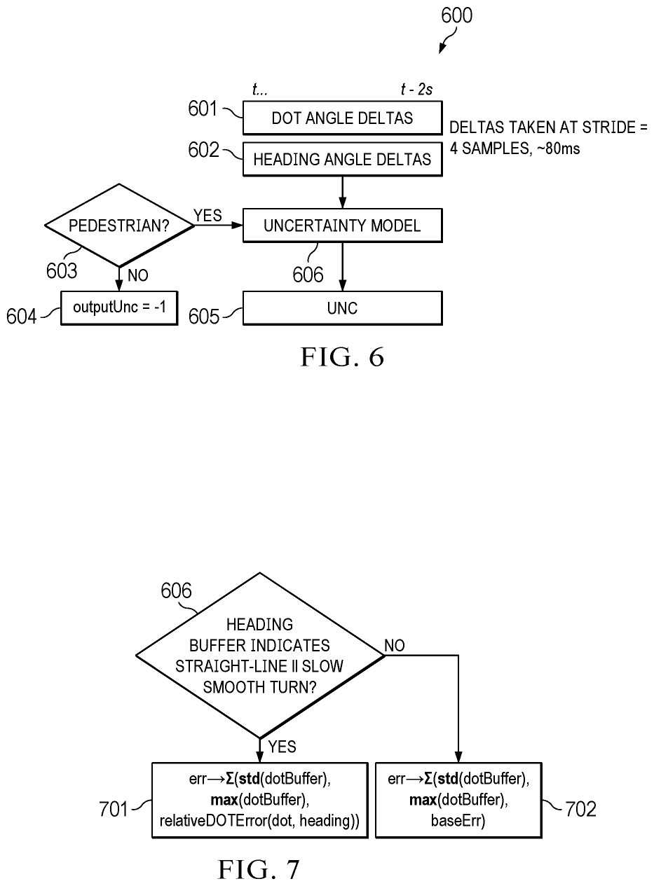

FIG. 6 is a flow diagram of logic for calculating a DoT uncertainty value with on-body device placement, according to one or more embodiments. In some embodiments, when in pedestrian mode 601 (e.g., as determined by pedestrian classifier 106 in FIG. 1) and with on-body placement (e.g., as determined by placement classifier 108), uncertainty model 606 calculates an uncertainty value 605 associated with the on-body DoT estimate based on features of DoT angle deltas 601 and heading angle deltas 602 (used as a reference) stored in buffers (e.g., 2 second buffers), which are taken at stride (e.g., 4 samples, ˜80 ms). In non-pedestrian mode 603, uncertainty value 605 is invalidated 604.

FIG. 7 is a flow diagram of uncertainty model 606 shown in FIG. 6, according to one or more embodiments. Uncertainty model 606 determines if the buffer of heading angle deltas indicates a straight line or a slow smooth turn. If yes, uncertainty value 701 is computed according to Equation [2]:

err→Σ(std(dotBuffer),max(dotBuffer),relativeDOTError(dot,heading)). [2]

Otherwise, uncertainty value 702 is computed according to Equation [3]:

err→Σ(std(dotBuffer),max(dotBuffer),baseErr). [3]

In Equation [2], std ( ) is a function that computes a standard deviation, dotBuffer is a buffer of DoT angles, max ( ) is a function that finds the maximum DoT angle in dotBuffer, base Err is an assumed default DoT bias error) and relative DOTError( ) is a function that computes the difference between DoT angles and reference heading angles. In some embodiments, the heading reference angle comes from a device motion 6-axis attitude estimation.

### Example In-Hand DoT Estimation

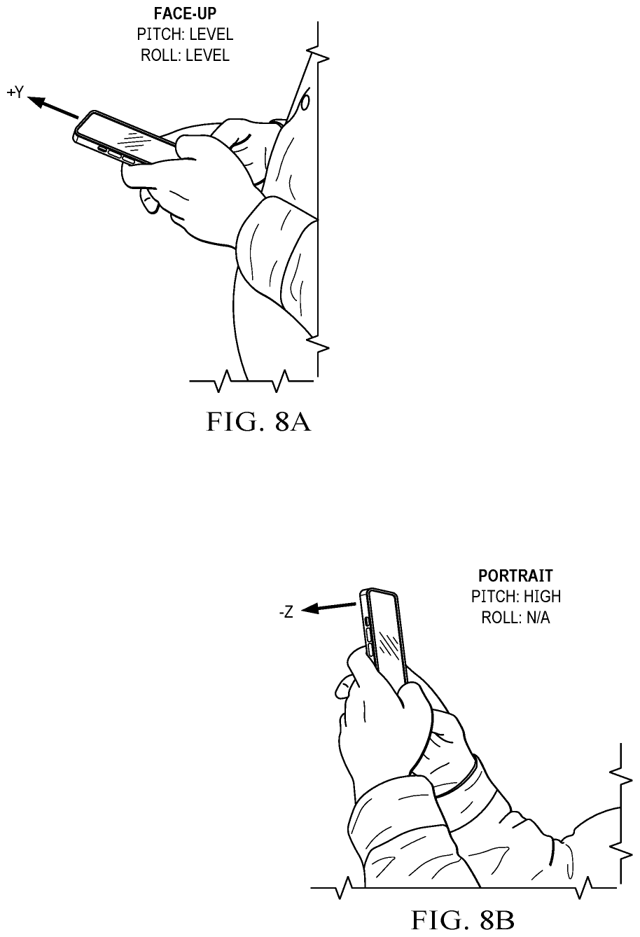

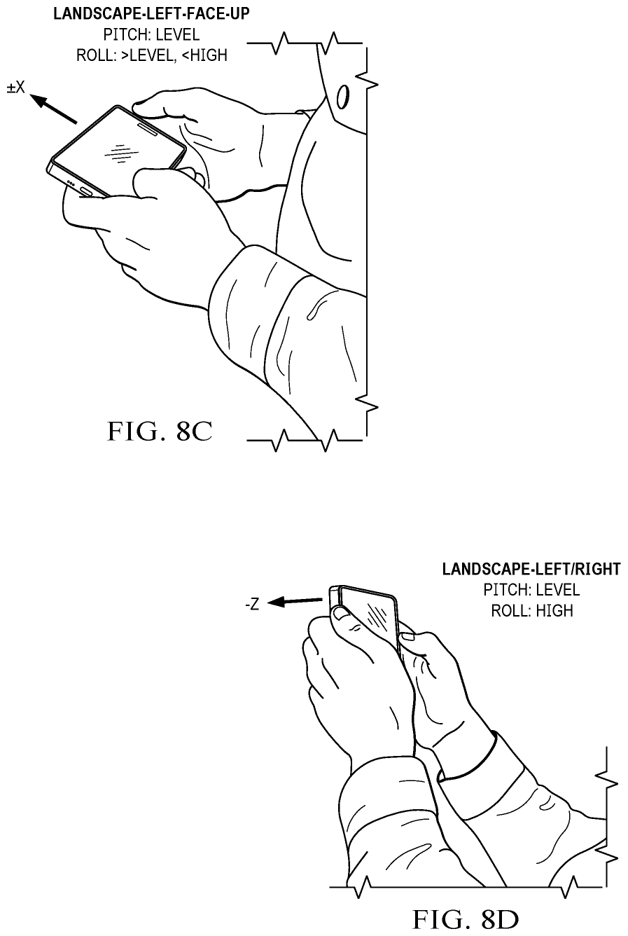

FIGS. 8A-8D illustrate determining DoT for in-hand device placement, according to one or more embodiments. When the device (e.g., a smartphone, tablet computer) is held in a user's hand and they are viewing the screen while walking, e.g., texting or otherwise interacting with the screen, the attitude (roll, pitch, yaw) of the device in a body reference frame is used to estimate DoT in a horizontal inertial reference frame.

Referring to FIG. 8A, the user is holding the device in a “face-up” orientation which is indicated by a level pitch and level roll in the body reference frame, where “level” means the pitch/roll angle is approximately zero in the body reference frame. In this example body reference frame, the +Y axis is directed out of the front of the device, the +X axis is directed out of the right side of the device and +Z axis projects out from the screen to complete a Cartesian reference frame according to the right-hand rule. In this orientation, the +Y axis projected into the inertial horizontal reference plane (e.g., using a body to inertial rotation transform or quaternion) provides an estimate of DoT.

Referring to FIG. 8B, the user is holding the device in a “portrait” orientation as shown, where the pitch is a high value (e.g., exceeds a specified high pitch threshold). In this orientation, the −Z axis projected into the inertial horizontal reference plane provides an estimate of DoT.

Referring to FIG. 8C, the user is holding the device in a “landscape-left-face-up” orientation as shown, which is detected when the pitch is level, the roll is greater than level and less than a high threshold. In this orientation, the +/−X body axis projected into the inertial horizontal reference plane provides an estimate of DoT.

Referring to FIG. 8D, the user is holding the device in a “landscape-Left/Right” orientation as shown, which is detected when the pitch is level, and the roll is high based on exceeding a high roll threshold. In this orientation, the −Z body axis projected into the horizontal inertial reference frame provides an estimated of DoT.

### Example System for Estimating DoT for Different Device Placements

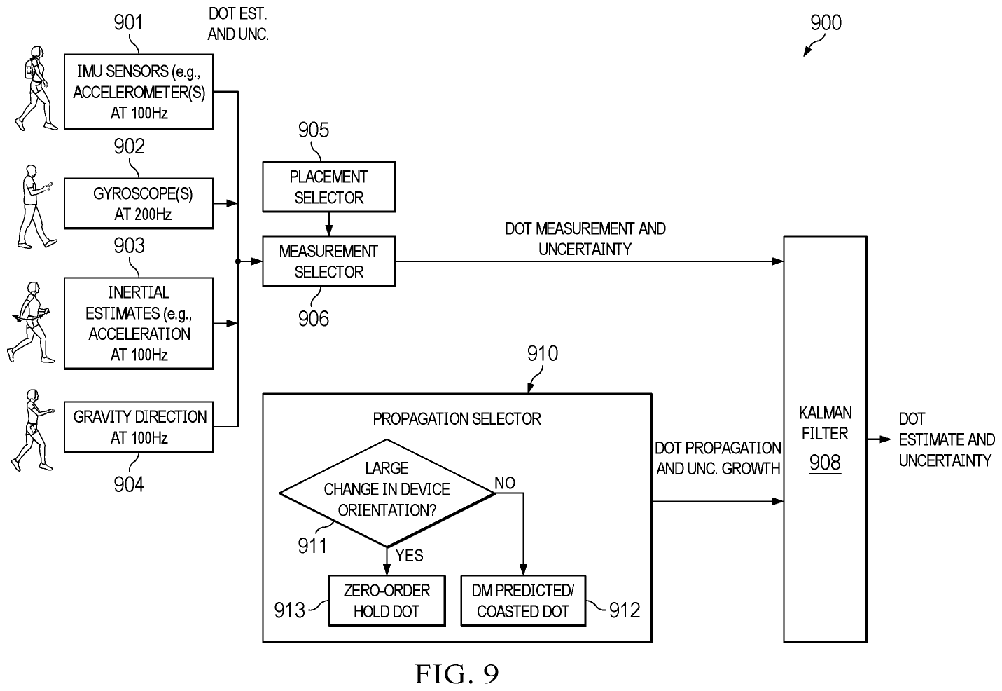

FIG. 9 is a block diagram of a system 900 for estimating DoT for different device placements, according to one or more embodiments. An estimated DoT and its associated uncertainty are computed for on-body 901 (e.g., based on acceleration from accelerometers), viewing 902 (e.g., based on rotation rate from gyroscopes), arm-swing 903 (e.g., based on acceleration from accelerometers) and leg-swing 904 (e.g., based on gravity direction). These estimated DoTs are observations that are selectively input into an estimation filter 908 (e.g., an extended Kalman filter) by measurement selector 906 based on output of placement classifier 905, described in reference to FIG. 1, in combination with some logic. For example, if placement classifier 905 indicates on-body, then the on-body estimate of DoT is input as a measurement into estimation filter 908. Similarly, if placement classifier 905 indicates another device placement (viewing 902, arm-swing 903, leg-swing 904), measurement selector 906 will input that measurement into estimation filter 908. However, if the DoT on-body estimate is unavailable or invalid, the measurement selector would fall back to viewing DoT estimate. Similar logic is present for other device placements indicated by placement classifier 905 (viewing 902, arm-swing 903, leg-swing 904) for measurement selector 906 to input a DoT measurement to estimation filter 908. Estimation filter 908 outputs an estimated DoT and its associated uncertainty.

Additionally, device motion 907 (e.g., acceleration including roll and pitch angles) is input into propagation selector 910, which outputs a predicted DoT and its associated uncertainty, which is input into estimation filter 908. Propagation selector 910 determines 911 a large variance in roll and pitch angles, which indicates a device location transition. If such a device location transition is determined a hold is applied to the DoT (device motion is not predicted/coasted forward in the DoT); otherwise, device motion 907 is predicted/coasted in the DoT and provided as input into estimation filter 908.

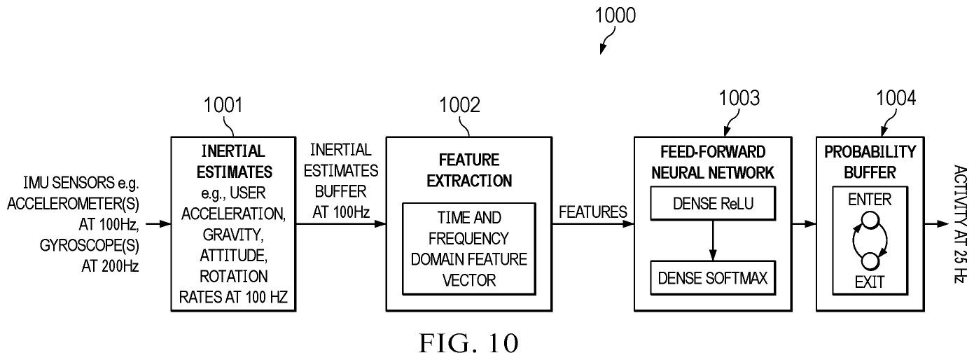

FIG. 10 is a block diagram of an activity classifier 1000, according to one or more embodiments. In some embodiments, activity classifier 1000 uses a neural network to classify an activity that a user is engaged including walking. Activity classifier 1000 can be used to implement pedestrian classifier 106 shown in FIG. 1. Activity classifier 1000 includes feature extraction 1002, neural network (NN) 1003 (e.g., a feed-forward NN), and probability buffer 1004. Inertial estimates 1001 (e.g., acceleration, gravity, attitude, rotation rates) are computed from sensor data output by motion sensors (e.g., accelerometers, gyroscopes) of the device. Feature extraction 1002 extracts various feature vector from the inertial sensor data (e.g., time and frequency domain characteristics), the feature vector is input to NN 1003, which predicts a probability of a particular user activity class (e.g., probability of pedestrian/walking). In some embodiments, NN 1003 includes a dense rectified linear unit (ReLU) activation function layer coupled to a dense softmax function layer to normalize the output of the ReLU to a probability distribution. NN 1003 can be trained using any known techniques (e.g., back propagation). Other NN configurations are also possible.

### Example Processes

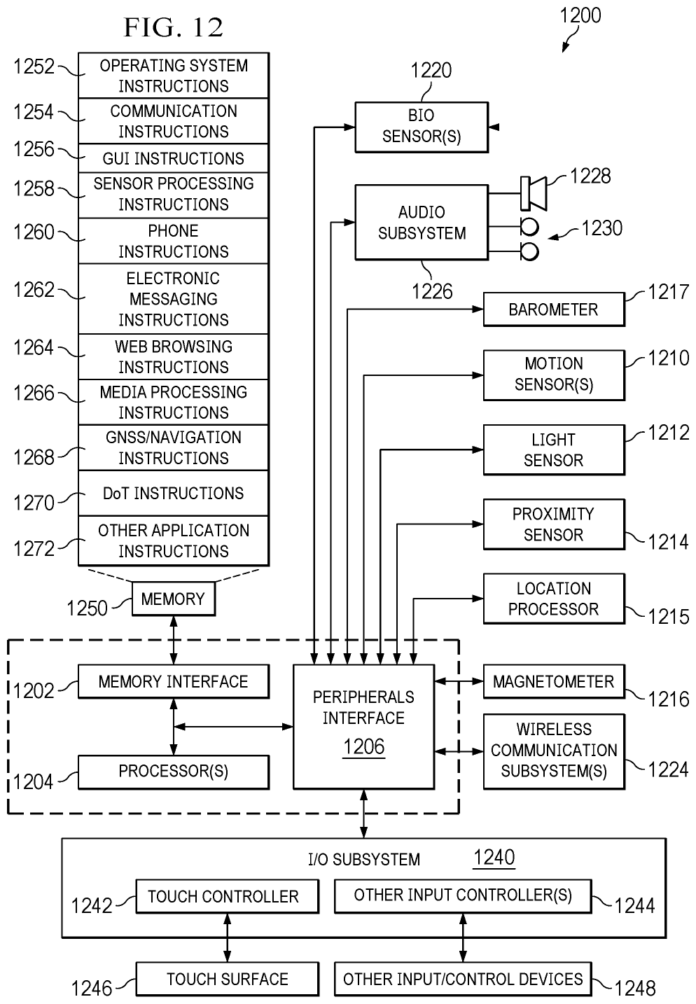

FIG. 11 is a flow diagram of a process 1100 for estimating velocity for different device placements, according to one or more embodiments. Process 1100 can be implanted using the device architecture described in reference to FIG. 12.

Process 1100 includes: obtaining device motion data from a mobile device (1101); determining a pedestrian/non-pedestrian class based on the device motion data (1202); determining the placement of device based on the device motion data (1103); estimating a first direction of travel based on multiple DoT sources and the device placement (1104); estimating a first velocity based on the pedestrian/non-pedestrian class, the first estimate of direction of travel, and a first estimate of speed (1105); estimating a second velocity based on a kinematic model and the device motion data (1106); selecting the first estimated velocity or the second estimated velocity based on selection logic (1107); and optionally determining relative position of the device based on the selected estimated velocity (1108).

The estimated DoT, relative position, estimated velocity and their respective associated uncertainties can be stored, sent to another device, or made available to one or more applications through a framework, operating system call, application programming interface (API) or any other mechanism for sharing data (e.g., shared memory).

### Example Device Architecture

FIG. 12 is a block diagram of a mobile device architecture for implementing the features and processes described in reference to FIGS. 1-11. Architecture 1200 can include memory interface 1202, one or more hardware data processors, image processors and/or processors 1204 and peripherals interface 1206. Memory interface 1302, one or more processors 1204 and/or peripherals interface 1206 can be separate components or can be integrated in one or more integrated circuits. System architecture 1200 can be included in any suitable electronic device for crash detection, including but not limited to: a smartwatch, smartphone, fitness band and any other device that can be attached, worn, or held by a user.

Sensors, devices, and subsystems can be coupled to peripherals interface 1206 to provide multiple functionalities. For example, one or more motion sensors 1210, light sensor 1212 and proximity sensor 1214 can be coupled to peripherals interface 1206 to facilitate motion sensing (e.g., acceleration, rotation rates), lighting and proximity functions of the wearable device. Location processor 1215 can be connected to peripherals interface 1206 to provide geo-positioning. In some implementations, location processor 1215 can be a GNSS receiver, such as the Global Positioning System (GPS) receiver. Electronic magnetometer 1216 (e.g., an integrated circuit chip) can also be connected to peripherals interface 1206 to provide data that can be used to determine the direction of magnetic North. Electronic magnetometer 1216 can provide data to an electronic compass application. Motion sensor(s) 1210 can include one or more accelerometers and/or gyros configured to determine change of speed and direction of movement. Barometer 1217 can be configured to measure atmospheric pressure (e.g., pressure change inside a vehicle). Bio signal sensor 1220 can be one or more of a PPG sensor, an electroencephalogram (EEG) sensor, an electrocardiogram (ECG) sensor, an electromyogram (EMG) sensor, a mechanomyogram (MMG) sensor (e.g., piezo resistive sensor) for measuring muscle activity/contractions, an electrooculography (EOG) sensor, a galvanic skin response (GSR) sensor, a magnetoencephalogram (MEG) sensor and/or other suitable sensor(s) configured to measure bio signals.

Communication functions can be facilitated through wireless communication subsystems 1224, which can include radio frequency (RF) receivers and transmitters (or transceivers) and/or optical (e.g., infrared) receivers and transmitters. The specific design and implementation of the communication subsystem 1224 can depend on the communication network(s) over which a mobile device is intended to operate. For example, architecture 1200 can include communication subsystems 1224 designed to operate over a GSM network, a GPRS network, an EDGE network, a Wi-Fi™ network and a Bluetooth™ network, 5G, 6G. In particular, the wireless communication subsystems 1224 can include hosting protocols, such that the crash device can be configured as a base station for other wireless devices.

Audio subsystem 1226 can be coupled to a speaker 1228 and a microphone 1230 to facilitate voice-enabled functions, such as voice recognition, voice replication, digital recording, and telephony functions. Audio subsystem 1226 can be configured to receive voice commands from the user. Audio subsystem 1226 can be used to capture audio during a crash and to convert the audio to SPL for crash detection processing.

I/O subsystem 1240 can include touch surface controller 1242 and/or other input controller(s) 1244. Touch surface controller 1242 can be coupled to a touch surface 1246. Touch surface 1246 and touch surface controller 1242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 1246. Touch surface 1246 can include, for example, a touch screen or the digital crown of a smart watch. I/O subsystem 1240 can include a haptic engine or device for providing haptic feedback (e.g., vibration) in response to commands from processor 1204. In an embodiment, touch surface 1246 can be a pressure-sensitive surface.

Other input controller(s) 1214 can be coupled to other input/control devices 1248, such as one or more buttons, rocker switches, thumbwheel, infrared port, and USB port. The one or more buttons (not shown) can include an up/down button for volume control of speaker 1228 and/or microphone 1230. Touch surface 1246 or other controllers 1244 (e.g., a button) can include, or be coupled to, fingerprint identification circuitry for use with a fingerprint authentication application to authenticate a user based on their fingerprint(s).

In one implementation, a pressing of the button for a first duration may disengage a lock of the touch surface 1246; and a pressing of the button for a second duration that is longer than the first duration may turn power to the mobile device on or off. The user may be able to customize a functionality of one or more of the buttons. The touch surface 1246 can, for example, also be used to implement virtual or soft buttons.

In some implementations, the mobile device can present recorded audio and/or video files, such as MP3, AAC and MPEG files. In some implementations, the mobile device can include the functionality of an MP3 player. Other input/output and control devices can also be used.

Memory interface 1202 can be coupled to memory 1250. Memory 1250 can include high-speed random-access memory and/or non-volatile memory, such as one or more magnetic disk storage devices, one or more optical storage devices and/or flash memory (e.g., NAND, NOR). Memory 1250 can store operating system 1252, such as the iOS operating system developed by Apple Inc. of Cupertino, California. Operating system 1252 may include instructions for handling basic system services and for performing hardware dependent tasks. In some implementations, operating system 1252 can include a kernel (e.g., UNIX kernel).

Memory 1250 may also store communication instructions 1254 to facilitate communicating with one or more additional devices, one or more computers and/or one or more servers, such as, for example, instructions for implementing a software stack for wired or wireless communications with other devices. Memory 1250 may include graphical user interface instructions 1256 to facilitate graphic user interface processing; sensor processing instructions 1258 to facilitate sensor-related processing and functions; phone instructions 1260 to facilitate phone-related processes and functions; electronic messaging instructions 1262 to facilitate electronic-messaging related processes and functions; web browsing instructions 1264 to facilitate web browsing-related processes and functions; media processing instructions 1266 to facilitate media processing-related processes and functions; GNSS/Location instructions 1268 to facilitate generic GNSS and location-related processes and instructions; and DoT instructions 1270 that implement the processes described in reference to FIGS. 1-11. Memory 1250 further includes other application instructions 1272 including but not limited to instructions for applications that utilize DoT.

Each of the above identified instructions and applications can correspond to a set of instructions for performing one or more functions described above. These instructions need not be implemented as separate software programs, procedures, or modules. Memory 1250 can include additional instructions or fewer instructions. Furthermore, various functions of the mobile device may be implemented in hardware and/or in software, including in one or more signal processing and/or application specific integrated circuits.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location-based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

What is claimed is:

1. A method comprising:
obtaining, with at least one processor, motion data from a motion sensor of a mobile device;
determining, with the at least one processor, pedestrian or non-pedestrian class based on the device motion data;
determining, with the at least one processor, a placement of the device based on the device motion data;
estimating, with the at least one processor, a first direction of travel based on multiple direction of travel sources and the device placement;
estimating, with the at least one processor, a first velocity based on the pedestrian or non-pedestrian classification, the first estimate of direction of travel and a first estimate of speed;
estimating, with the at least one processor, a second velocity based on a kinematic model and the device motion data;
selecting, with the at least one processor, the first estimated velocity or the second estimated velocity based on selection logic; and
determining, with the at least one processor, a relative position of the device based on the selected estimated velocity.

2. An apparatus comprising:
at least one processor;
memory storing instructions that when executed by the at least one processor, cause the at least one processor to perform the method of claim 1.

3. A computer-readable storage medium having instructions stored thereon, that when executed by one or more processors, perform the method of claim 1.
